(19) United States
(12) Patent Application Publication
(10) Pub. No.: US 2019/0000043 A1
(43) Pub. Date: Jan. 3, 2019

(54) ANIMAL LEASH

(71) Applicant: MY CLEVER DOG PTY LTD, Largs Bay (AU)

(72) Inventors: Justin Anthony Daley, Largs Bay (AU); George Giles Campbell, Brighton (AU)

(21) Appl. No.: 16/060,444

(22) PCT Filed: Dec. 9, 2016
(86) PCT No.: PCT/AU2016/000393

§ 371 Date: Jun. 8, 2018

(30) Foreign Application Priority Data
Dec. 11, 2015 (AU) 2015905134

(51) Int. Cl. A01K 27/00

(52) U.S. Cl. CPC A01K 27/004; A01K 27/005

(57) ABSTRACT

A retractable animal leash assembly is disclosed. The animal leash assembly comprises a housing comprising an external surface having an ergonomically shaped hand grip portion. The animal leash assembly also comprises a retractable flexible leash extendable from and retractable into the housing, a distal end of the leash having an attachment clip configured to be releasably attached to an attachment point on a collar or harness on an animal. The animal leash assembly also comprises an actuator operable from the external surface and configured to move the attachment clip between a locked configuration in which the attachment clip is configured so that it cannot be detached from the attachment point on the collar or harness, and an open configuration in which the attachment clip can be attached to or detached from the attachment point on the collar or harness. In use, a user is able to move the attachment clip between the locked configuration and the open configuration using the actuator remotely from the attachment clip.

### PRIORITY DOCUMENT

The present application claims priority from International Patent Application No. PCT/AU2016/000393 filed on Dec. 9, 2016, and Australian Provisional Patent Application No. 2015905134 titled “ANIMAL LEASH” and filed on 11 Dec. 2015, the content of which is hereby incorporated by reference in its entirety.

### TECHNICAL FIELD

The present disclosure relates to an improved animal leash, such as a dog leash.

### BACKGROUND

Animal leashes, such as dog leashes, are commonly used to restrain pets when they are outside and particularly in public places. Many local government laws require pet owners to have their pets on a leash when they are in public open areas, such as beaches and parks. Animal leashes are also very useful in training pets.

Known animal leash designs are sometimes not all that easy to use. For example, it can be difficult to hold an animal still long enough to connect a leash to a collar or harness on the animal. Furthermore, some leashes are cumbersome and uncomfortable for an animal handler to hold for anything other than brief periods.

A number of attempts have been made to resolve the foregoing problems. However, the present applicant is not aware of any animal leash that addresses these issues. There is thus a need to provide an improved animal leash, such as one that is relatively easy to use and comfortable for the user even when used for long periods of time and/or with large animals.

### SUMMARY

The present disclosure arises from research and development into ergonomically shaped animal leashes that allow an animal handler to attach and detach the leash to and from a collar or harness on an animal without having to manipulate the clip on the leash in one hand whilst holding the leash in the other hand.

According to a first aspect, there is provided a retractable animal leash assembly comprising:
a housing comprising an external surface having an ergonomically shaped hand grip portion;
a retractable flexible leash extendable from and retractable into the housing, a distal end of the leash having an attachment clip configured to be releasably attached to an attachment point on a collar or harness on an animal; and
an actuator operable from the external surface and configured to move the attachment clip between a locked configuration in which the attachment clip is configured so that it cannot be detached from the attachment point on the collar or harness, and an open configuration in which the attachment clip can be attached to or detached from the attachment point on the collar or harness,
   wherein, in use, a user is able to move the attachment clip between the locked configuration and the open configuration using the actuator remotely from the attachment clip.

In certain embodiments, the housing encompasses an internal volume.

In certain embodiments, the assembly further comprises a retractable reel rotatably mounted in the internal volume, the reel having the flexible leash connected thereto for extension from and retraction onto the reel through a leash aperture in the housing.

In certain embodiments, the attachment clip comprises a clip portion and a latch portion, the latch portion being moveable with respect to the clip portion between the locked configuration in which the clip portion and latch portion securely connect the leash to the attachment point on the collar so that it cannot be detached therefrom and the open configuration in which there is an opening between the clip portion and the latch portion to allow the attachment clip to be attached to or detached from the attachment point on the collar or harness. In certain embodiments, the latch portion is biased to the locked configuration.

In certain embodiments, the assembly further comprises a bearing surface proximal the leash aperture in the housing. In these embodiments, the actuator is operable from the external surface and is configured to move the attachment clip between a non-active position in which the latch portion is in the locked configuration and an active position in which at least part of the latch portion bears against the bearing surface such that the bearing surface overcomes the bias on the latch portion and maintains the latch portion in the open configuration, and wherein the attachment clip is biased to the non-active position.

It will be evident from the foregoing that, in a second aspect, there is provided a retractable animal leash assembly comprising:
a housing encompassing an internal volume and comprising an external surface having an ergonomically shaped hand grip portion;
a retractable reel rotatably mounted in the internal volume, the reel having a flexible leash connected thereto for extension from and retraction onto the reel through a leash aperture in the housing;
the leash having a proximal end and a distal end, the proximal end securely connected to the reel and the distal end including an attachment clip configured to be releasably attached to an attachment point on a collar or harness on an animal;
the attachment clip comprising a clip portion and a latch portion, the latch portion being moveable with respect to the clip portion between a locked configuration in which the clip portion and latch portion securely connect the leash to the attachment point on the collar and an open configuration in which there is an opening between the clip portion and the latch portion to allow the attachment clip to be fitted to or released from the attachment point on the collar or harness and wherein the latch portion is biased to the locked configuration;
a bearing surface proximal the leash aperture in the housing;
an actuator operable from the external surface and configured to move the attachment clip between a non-active position in which the latch portion is in the locked configuration and an active position in which at least part of the latch portion bears against the bearing surface such that the bearing surface overcomes the bias on the latch portion and maintains the latch portion in the open configuration, and wherein the attachment clip is biased to the non-active position.

In certain embodiments of the first and second aspects, the animal leash assembly further comprises a light region on the housing, the light region comprising a light source and a light cover and operable to project light in a desired direction from the assembly.

In certain embodiments of the first and second aspects, the hand grip portion is in the form of a pistol grip.

In certain embodiments of the first and second aspects, the hand grip portion comprises an elastomeric palm grip portion.

### BRIEF DESCRIPTION OF DRAWINGS

Embodiments of the present invention will be discussed with reference to the accompanying drawings wherein:

FIG. 1 is an isometric view from one end of an animal leash in accordance with an embodiment of the present disclosure;

FIG. 2 is an isometric view from another end of an animal leash in accordance with an embodiment of the present disclosure;

FIG. 3 is a side view of an animal leash in accordance with an embodiment of the present disclosure;

FIG. 4 is a side view of an animal leash in accordance with an embodiment of the present disclosure;

FIG. 5 is a top view of an animal leash in accordance with an embodiment of the present disclosure;

FIG. 6 is a bottom view of an animal leash in accordance with an embodiment of the present disclosure;

FIG. 7 is an end view of an animal leash in accordance with an embodiment of the present disclosure;

FIG. 8 is another end view of an animal leash in accordance with an embodiment of the present disclosure;

FIG. 9 is an exploded isometric view of an animal leash in accordance with an embodiment of the present disclosure;

FIG. 10 is an partially exploded isometric view of an animal leash in accordance with an embodiment of the present disclosure;

FIG. 11 is a side view of one half section of an animal leash in accordance with an embodiment of the present disclosure showing the attachment clip in a non-active configuration; and

FIG. 12 is a side view of one half section of an animal leash in accordance with an embodiment of the present disclosure showing the attachment clip in an active configuration.

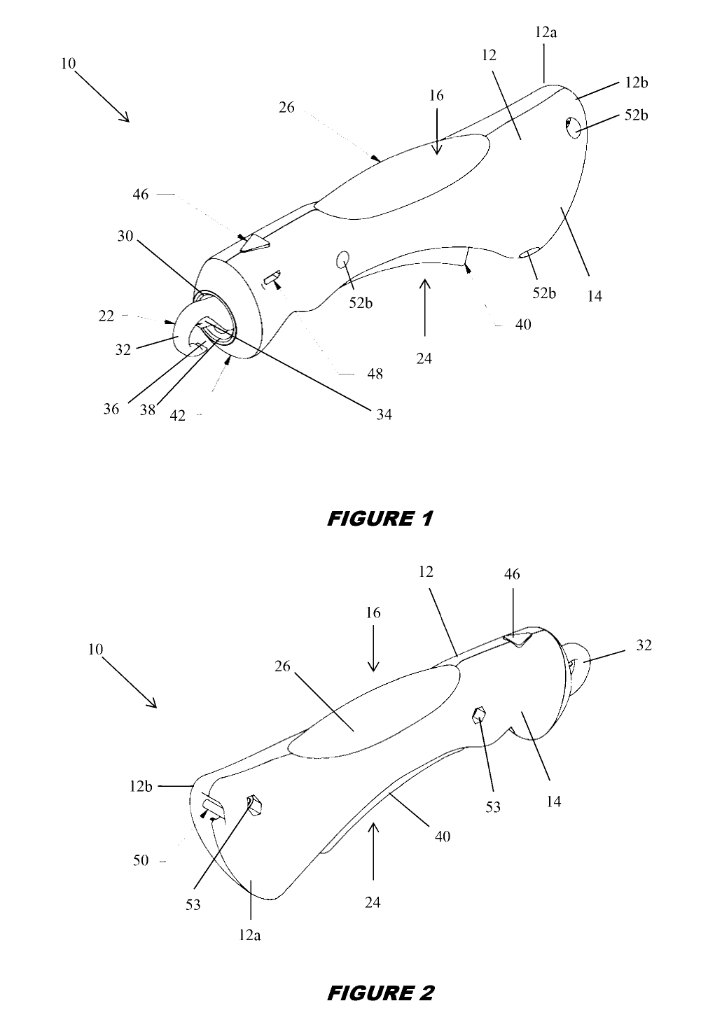

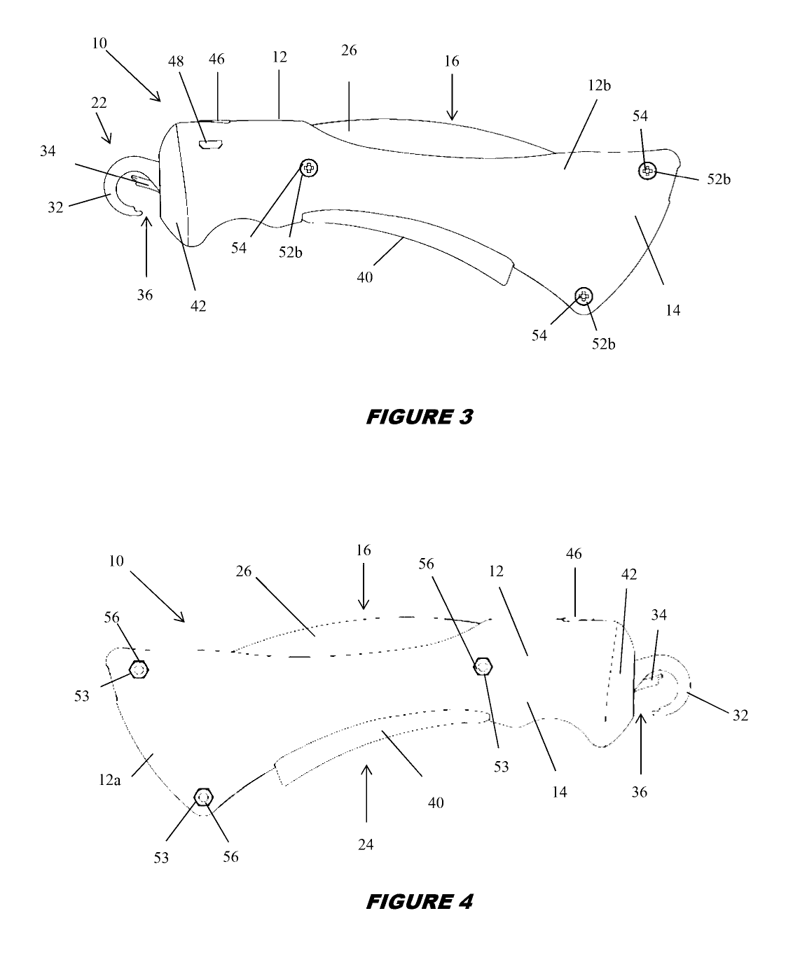

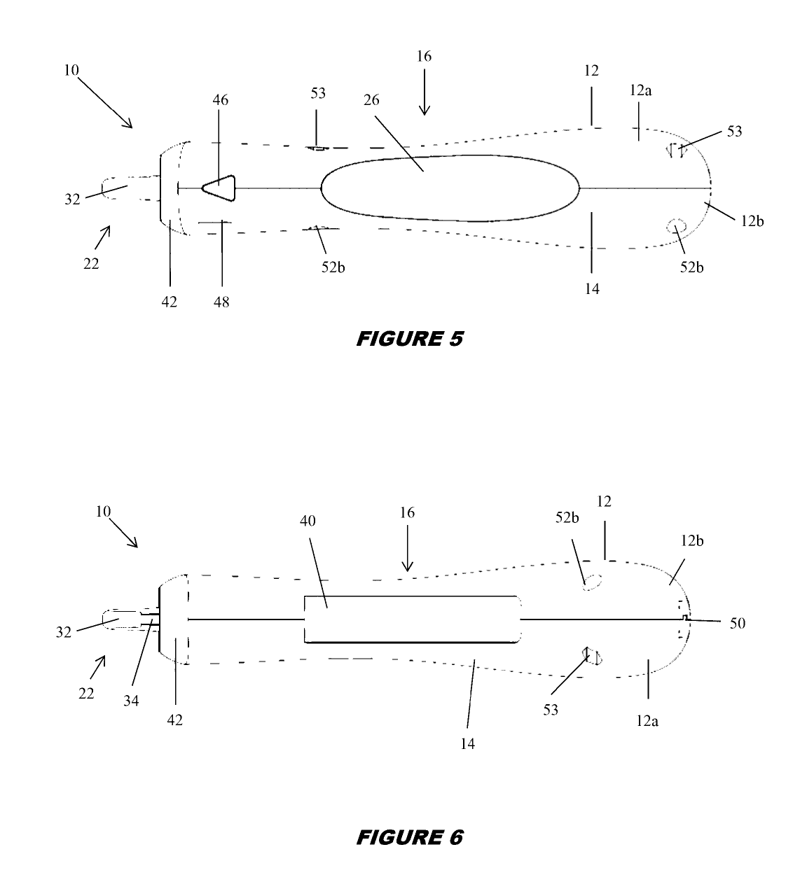

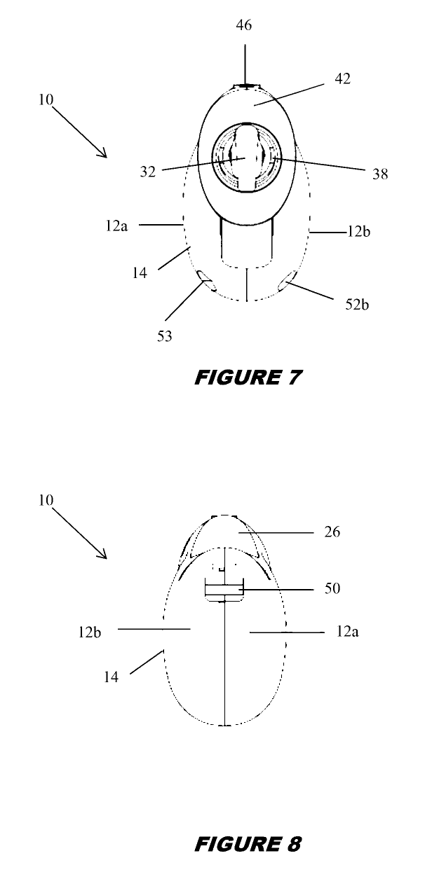

In the following description, like reference characters designate like or corresponding parts throughout the figures.

### DESCRIPTION OF EMBODIMENTS

Referring now to the figures, there is generally shown a retractable animal leash assembly 10. The assembly 10 comprises a housing 12 comprising an external surface 14 having an ergonomically shaped hand grip portion 16. A retractable flexible leash 18 is extendable from and retractable into the housing 12. A distal end 20 of the leash 18 has an attachment clip 22 configured to be releasably attached to an attachment point on a collar or harness on an animal (not shown). An actuator 24 is operable from the external surface 14 and is configured to move the attachment clip 22 between a locked configuration in which the attachment clip 22 is configured so that it cannot be detached from the attachment point on the collar or harness, and an open configuration in which the attachment clip 22 can be attached to or detached from the attachment point on the collar or harness. In use, a user is able to move the attachment clip 22 between the locked configuration and the open configuration using the actuator 24 remotely from the attachment clip 22.

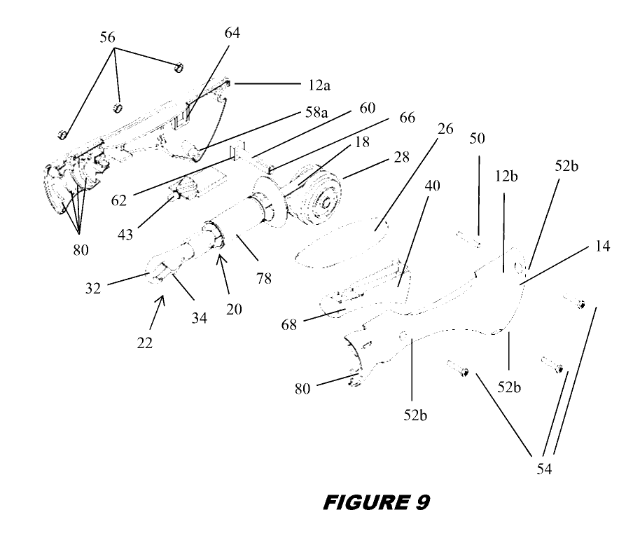

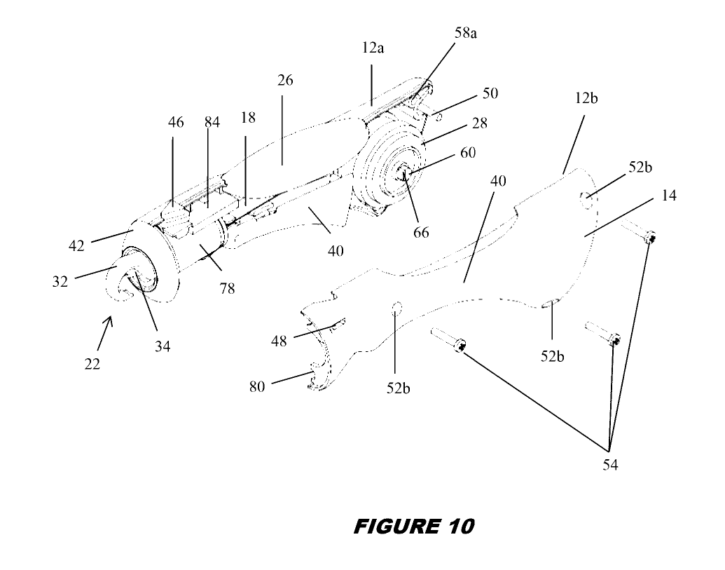

The housing 12 encompasses an internal volume (best seen in FIGS. 9 to 12) that can be used to house the flexible leash 18 and other components, as described in more detail later. The housing 12 can be formed from any suitable material, such as metal or a suitable plastic material. The housing 12 can be formed using any suitable technique. In the case of a plastic housing, the housing 12 can be formed using any suitable plastics moulding technique. The housing 12 can comprise multiple parts that are manufactured separately and subsequently assembled. For example, the housing 12 may be formed in two halves and subsequently assembled and joined together using any suitable fixing, such as bolts, screws, rivets, glues, adhesives, interference fit components, etc. As best seen in FIGS. 9 and 10, in the illustrated embodiments the housing 12 comprises two housing parts 12a and 12b. One of the housing parts 12a has a plurality of bolt apertures 52a formed therein. A nut receiving depression 53 is formed on external surface 14 at the location of each of the bolt apertures 52a. The other housing part 12b has a plurality of complementary bolt apertures 52b accessible from the external surface 14. Bolts 54 are journaled through the bolt apertures 52b and threaded into complementary nuts 56 that are positioned in each nut receiving depression 53 on the other housing part 12a in order to assemble the leash assembly 10 and secure the housing parts 12a and 12b. Hollow spacer posts 58 are formed on an internal surface of each of the housing parts 12a and 12b. The spacer posts 58a on housing part 12a are aligned with bolt apertures 52a. The spacer posts 58 are not shown on housing part 12b but they are aligned with bolt apertures 52b. Complementary spacer posts 58 on each housing part 12a and 12b bear against one another when the housing parts 12a and 12b are secured together and allow the bolts 54 and nuts 56 to be tightened without overly compressing the housing parts 12a and 12b. As mentioned, other methods for securing housing parts 12a and 12b could alternatively be used.

In the illustrated embodiments, the hand grip portion 16 is in the form of a pistol grip. This provides a comfortable arrangement for a user to hold the assembly in one hand. Furthermore, in the illustrated embodiments the hand grip portion 16 comprises an elastomeric palm grip portion 26. In use, the elastomeric palm grip portion 26 sits in the palm of a user's hand and this provides a comfortable and ergonomic experience for the user. The elastomeric grip portion can be made from any suitable elastomeric material and can be attached to the housing 12 using any suitable method known to those skilled in the art, such as by an adhesive, fastener, etc. In the illustrated embodiment, the elastomeric palm grip portion 26 is held on the housing by an interference fit within a depression 82 on the top surface of the housing 12.

The flexible leash 18 can be extended from and retracted into the housing 12 using any suitable mechanism. In the illustrated embodiments, the flexible leash 18 is attached to a retractable reel 28 which, in turn, is rotatably mounted in the internal volume. The retractable reel 28 is rotatable with respect to the housing 12. The leash 18 can be wound from or onto the reel 28, respectively to extend and retract the leash 18 from the housing 12. The leash 18 passes from the reel 28 through a leash aperture 30 in the housing 12.

A proximal end of the leash 18 is securely connected to the reel 28 and the distal end 20 includes the attachment clip 22. The attachment clip 22 is securely attached to the leash 18. The attachment clip 22 can be secured to the leash 18 using any suitable method or device known to those skilled in the art. Suitable attachment methods and devices include buckles, etc.

The retractable reel 28 is journaled for rotation on an axle shaft 60. The axle shaft 60 is fixed in the internal volume. The axle shaft 60 has at least one keyed end which keys into a correspondingly keyed axle holder formed on the internal surface of the housing. In the illustrate embodiments, the axle shaft 60 has a shaped end 62 which can be fitted into a correspondingly shaped receiving portion 64 formed on an internal surface of housing part 12a. The other end of the axle shaft 60 is also keyed and comprises a flattened section 66 that can be fitted into a corresponding receiving section (not shown) formed on an internal surface of the housing part 12b. In use, the axle shaft 60 is non-rotatable relative to the housing 12 and the retractable reel 28 rotates relative to the axle shaft 60. In other embodiments that are not illustrated, the axle shaft 60 may be fixed to the retractable reel 28 and the axle shaft 60 may rotate relative to the housing 12.

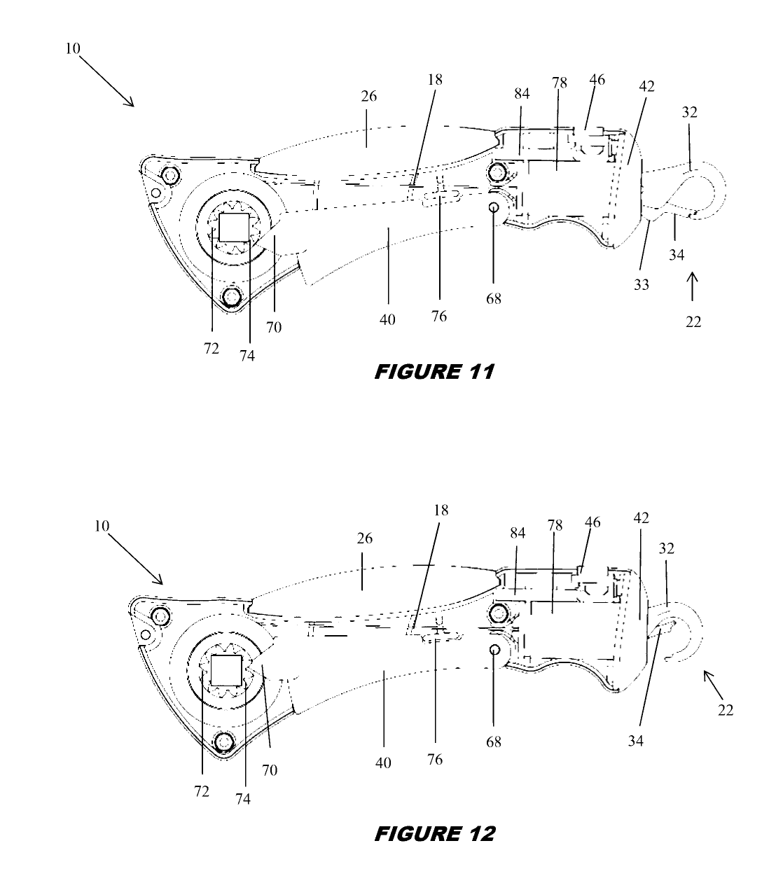

The attachment clip 22 comprises a clip portion 32 and a latch portion 34. The latch portion 34 is moveable with respect to the clip portion 32 between a locked configuration (best seen in FIG. 11) in which the clip portion 32 and latch portion 34 are able to securely connect the leash 18 to the attachment point on the collar and an open configuration (best seen in FIG. 12) in which there is an opening 36 between the clip portion 32 and the latch portion 34 to allow the attachment clip 22 to be attached to or detached from the attachment point on the collar. The latch portion 34 is biased to the locked configuration. This means that the attachment clip 22 is normally in the locked configuration and a force has to be applied against the bias to move the latch portion 34 to the open configuration.

The attachment clip 22 may be constructed in any of the various forms known to those skilled in the art for affixing a leash to an animal collar. For example, the attachment clip 22 may take the form of a spring loaded metal closure controlled by a tab. Other common clips such as carabineers could be used. The latch portion 34 may slide between the open configuration and the closed configuration to provide the requisite opening 36. However, in the illustrated embodiments, the latch portion 34 pivots between the closed configuration and the open configuration.

The attachment clip 22 is moved between the locked configuration and the open configuration using the actuator 24 remotely from the attachment clip 22, as described in detail below.

The housing 12 has a bearing surface 38 adjacent the leash aperture 30. As best shown in FIGS. 11 and 12, the actuator 24 is operable from the external surface 14 and is configured to move the attachment clip 22 between a non-active position in which the latch portion 34 is in the locked configuration and an active position in which at least part of the latch portion 34 bears against the bearing surface 38 such that the bearing surface overcomes the bias on the latch portion 34 and forces the latch portion 34 to the open configuration. The attachment clip 22 is biased to the non-active position. In the illustrated embodiments, the latch portion 34 has a protrusion 33 extending outwardly therefrom. In use, the protrusion 33 bears against the bearing surface 38 when the attachment clip 22 is moved to the active position which forces the latch portion 34 to the open position.

In the illustrated embodiments, the leash aperture 30 is defined at least in part by a collar sleeve 78 through which the leash 18 passes. The internal diameter of the collar sleeve 78 is less than a maximum width of the attachment clip 22 which means that, once assembled, the attachment clip 22 is not able to be retracted into the housing 12. The collar sleeve 78 is held in place in the assembly 10 by a plurality of radially inwardly projecting annular segments 80 formed on the inner surfaces of the housing parts 12a and 12b. The final diameter of apertures formed by the radially inwardly projecting annular segments 80 are less than the outer diameter of the collar sleeve 78 at the ends of the collar sleeve 78 when the housing parts 12a and 12b are assembled and this prevents lateral movement of the collar sleeve 78 in the assembly 10.

In the illustrated embodiments, the actuator 24 is in the form of a trigger handle 40. The trigger handle 40 is located on the underside of the housing 12 and in normal use a user's fingers would be wrapped around the trigger handle 40. The trigger handle 40 is pivotable with respect to the housing 12 and a small movement in the trigger handle 40 can be used to bring the attachment clip 22 into the active position in which the latch portion 34 is in the open configuration. Once a collar or harness has been introduced into the attachment clip 22 the trigger handle 40 is released and this results in the bias forcing the attachment clip 22 to the non-active position and the latch portion 34 to the locked position. The attachment clip 22 (and leash 18) are then securely attached to the collar or harness. The attachment clip 22 can then only be released from the collar or harness by depressing the trigger handle 40 to bring the attachment clip 22 to the active position and the latch portion 34 to the open configuration.

The trigger handle 40 is pivotably mounted to the internal surface of housing parts 12a and 12b. Specifically, one end of the trigger handle has a shaft aperture 68 through which is journaled one of the bolts 54 used to secure the two housing parts 12a and 12b together. In this way, the bolt 54 acts as a pivot shaft for the trigger handle 40. Other methods and devices for pivotably mounting the trigger handle 40 with respect to the housing 12 could also be used. For example, the trigger handle 40 may be formed with shaft protrusions on each side and the shaft protrusions may engage with corresponding shaft receiving portions formed on the inner surfaces of housing parts 12a and 12b when the housing parts 12a and 12b are secured together.

The trigger handle 40 is biased to a non-depressed position in which the attachment clip 22 is in the non-active position. The bias can be provided by a torsion spring located near the pivot point of the handle. Other biasing means know to those in the art could also be used. However, in the illustrated embodiments the bias on trigger handle is provided by the bias of the retractable reel 28, as described in more detail later.

As discussed, lateral movement of the leash 18 and the attachment clip 22 to move the attachment clip 22 between the active and non-active positions is effected using the trigger handle 40. In the illustrated embodiments, this lateral movement is effected by a two way ratchet mechanism. However, it is contemplated that any mechanism that allows movement of the trigger handle 40 to actuate the desired lateral movement of the leash 18 and the attachment clip 22 could be used. In the illustrated embodiments, the trigger handle 40 has a pawl 70 at a free end. The pawl 70 is integrally formed as part of the trigger handle 40 but it could also be formed separately from the handle and subsequently attached thereto. A ratchet wheel 72 is connected to the retractable reel 28. The ratchet wheel 72 is integrally formed on one side of the retractable reel 28. However, the ratchet wheel 72 could also be mounted on axle shaft 60 separately from the retractable reel 28. The ratchet wheel 72 is rotatable with respect to the housing 12. The pawl 70 on the free end of the trigger handle 40 bears against a surface of a tooth 74 on the ratchet wheel 72. When the trigger handle 40 is depressed by a user, the pawl 70 engages the ratchet wheel 72 between adjacent teeth 74 and drives a small rotation of the ratchet wheel 72 and the retractable reel 28. This results in retraction of the leash 18 further onto the retractable reel 28 which, in turn, forces the latch portion 34 of attachment clip 22 on to the bearing surface 38 which overcomes the bias on the latch portion 34 and forces the latch portion 34 to the open configuration. Whilst the trigger handle 40 remains depressed, the pawl 70 is engaged with the ratchet wheel 72 between adjacent teeth 74 and the ratchet wheel 72 and retractable reel 28 are not rotatable. The degree to which the trigger handle can be depressed or pivoted is limited by a stop 76. The stop 76 is integrally formed on the inner surface of housing part 12a. The stop 76 is positioned and configured so that pawl 70 is engaged between adjacent teeth 74 and the depth of the pawl 70 in the space between adjacent teeth means that the ratchet wheel cannot move relative to the pawl 70. When the trigger handle 40 is released, the pawl 70 drives a small rotation of the ratchet wheel 72 and the retractable reel 28 in the opposite direction to the rotation when the trigger handle 40 is depressed. This results in extension of the leash 18 from the retractable reel 28 which, in turn, releases the latch portion 34 of attachment clip 22 from the bearing surface 38 and the bias on the latch portion 34 results in it returning to the closed configuration.

The pawl 70 and ratchet wheel 72 together provide a clutch arrangement. The retractable reel 28 is biased to a retracted position by a suitable biasing means. In the illustrated embodiments, a biasing spring (not shown) biases the retractable reel 28 so that the leash 18 and attachment clip 22 are biased to the retracted position. Other biasing means known to those in the art could also be used. When the trigger handle 40 is not depressed, the ratchet wheel 72 and retractable reel 28 are free to rotate. Thus, when a force is applied by a user or animal to pull the attachment clip 22 and/or leash 18 to extend it from the housing 12 the extension works against the bias of the retractable reel 28. However, when the force is released the bias acts to retract the leash 18 onto the retractable reel 28. When the leash 18 and attachment clip 22 are extended from the housing 12 and the trigger handle 40 is depressed, the pawl 72 engages the ratchet wheel 72 and prevents further rotation of the ratchet wheel 72 and the retractable reel 28. In this way, extension or retraction of the leash 18 from or into the housing 12 can be stopped by depressing the trigger handle 40. Thus, the length of the leash 18 can be controlled as may be required in cases where the distance of an animal from the user needs to be controlled. Thus, a user can maintain the assembly 10 with the trigger handle 40 not depressed in which case the length of the leash 18 extending from the housing 12 will vary depending on the amount of force applied to the leash 18, or the trigger handle 40 can be maintained in the depressed configuration in which case the length of the leash 18 will remain fixed. The ergonomic configuration of assembly 10 combined with the position of the trigger handle 40 and the degree of pivot required to depress the trigger handle 40 mean that the assembly is comfortable and easy to use with the trigger handle depressed or not depressed for long periods of time.

Thus, to attach the leash assembly 10 to a collar or harness on an animal, a user operates the actuator 24 which causes the attachment clip 22 to be drawn slightly into the housing 12. When this happens the bearing surface 38 pushes against the latch portion 34, causing it to pivot inwardly and form an opening 36 between the latch portion 34 and the clip portion 32. Thus, the actuator 24 is used to bring the attachment clip 22 into the open configuration in which it can be attached or detached to the collar or harness. This means that the user does not have to touch the attachment clip 22 at all and it is controlled from the housing 12.

Advantageously, the animal leash assembly 10 is relatively easy to use. Rather than having to manipulate clips on the ends of prior art leashes, to connect the leash assembly 10 to a collar or harness on an animal, a user operates the actuator 24 which causes the attachment clip 22 to the open configuration in which it can be attached or detached to the collar or harness. Furthermore, when the actuator 24 is operated the attachment clip 22 is pulled tightly against the bearing surface 38 which secures the attachment clip 22 from moving and makes it easy to control in three dimensional space and clip onto the collar. Essentially, in this configuration the assembly 10 is effectively a rigid clip 22 on a long handle which does not swing and/or swivel around. This means that the user does not have to touch the attachment clip 22 at all during attachment and detachment from the attachment point. Furthermore, the attachment and detachment can be carried out with one hand, that being the hand holding the assembly 10.

In the illustrated embodiments, the animal leash assembly 10 further comprises a light region 42 on the housing 12. The light region 42 comprises one or more light sources 43 and a light cover 44. The light region 42 is operable to project light in a desired direction from the assembly 10. The light sources can be any suitable powered light sources. For example, one or more light emitting diodes (LEDs) can be used as light sources. The light sources may be powered by a DC power source 84 located in the internal volume. A switch 46 is positioned on the external surface 14 and is accessible by a user's fingers or thumb when the user is holding the assembly 10. The switch 46 is electrically connected to the power source and the light source(s), as is known in the art. One or more light sources may be used and it is not necessary to have a light cover 44 in some embodiments. Rather, one or more LEDs may be located at selected positions on the external surface 14, as required.

A charging connector point 48 is accessible on the external surface 14 and allows a user to charge or re-charge the DC power source as required.

The external surface 14 also has a wrist strap connector 50 to which a wrist strap or other suitable tether can be attached. The wrist strap or tether can be wound around the user's wrist to provide extra security should the leash assembly 10 fall or be removed from the user's hand.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A retractable animal leash assembly comprising:
a housing comprising an external surface having an ergonomically shaped hand grip portion;
a retractable flexible leash extendable from and retractable into the housing, a distal end of the leash having an attachment clip configured to be releasably attached to an attachment point on a collar or harness on an animal; and
an actuator operable from the external surface and configured to move the attachment clip between a locked configuration in which the attachment clip is configured so that it cannot be detached from the attachment point on the collar or harness, and an open configuration in which the attachment clip can be attached to or detached from the attachment point on the collar or harness,
wherein, in use, a user is able to move the attachment clip between the locked configuration and the open configuration using the actuator remotely from the attachment clip.

2. A retractable animal leash assembly comprising:
a housing encompassing an internal volume and comprising an external surface having an ergonomically shaped hand grip portion;
a spring-loaded, retractable reel rotatably mounted in the internal volume, the reel having a flexible leash connected thereto for extension from and retraction into the reel through a leash aperture in the housing;
the leash having a first end and a second end, the first end securely connected to the reel and the second end including an attachment clip configured to be releasably attached to the attachment point on the collar or harness on an animal;
the attachment clip comprising a clip portion and a latch portion, the latch portion being moveable with respect to the clip portion between a locked configuration in which the clip portion and latch portion securely connect the leash to the attachment point on the collar and an open configuration in which there is an opening between the clip portion and the latch portion to allow the attachment clip to be fitted to or released from the attachment point on the collar and wherein the latch is biased to the locked configuration;
a bearing surface adjacent the leash aperture in the housing;
an actuator operable from the external surface and configured to move the attachment clip between a non-active position in which the latch portion is in the locked configuration and an active position in which at least part of the latch portion bears against the bearing surface such that the bearing surface overcomes the bias on the latch portion and maintains the latch portion in the open configuration, and wherein the attachment clip is biased to the non-active position.

3. The retractable animal leash assembly according to either claim 1 or claim 2, wherein, the hand grip portion is in the form of a pistol grip.

4. The retractable animal leash assembly according to any one of claims 1 to 3, wherein the hand grip portion comprises an elastomeric palm grip portion.

5. The retractable animal leash assembly according to any one of claims 1 to 4, wherein the assembly further comprises a light region on the housing, the light region comprising a light source and operable to project light in a desired direction from the assembly.

6. The retractable animal leash assembly according to any one of claims 2 to 5, wherein the flexible leash passes from the retractable reel through a leash aperture in the housing.

7. The retractable animal leash assembly according to any one of claims 2 to 5, wherein the latch portion has a protrusion extending outwardly therefrom and wherein, in use, the protrusion bears against the bearing surface when the attachment clip is moved to the active position which forces the latch portion to the open position.

8. The retractable animal leash assembly according to any one of claims 6 to 7, wherein the leash aperture is defined at least in part by a collar sleeve through which the leash passes.

9. The retractable animal leash assembly according to claim 8, wherein an internal diameter of the collar sleeve is less than a maximum width of the attachment clip which means that, once assembled, the attachment clip is not able to be retracted into the housing.

10. The retractable animal leash assembly according to any one of claims 1 to 9, wherein the actuator is in the form of a trigger handle.

11. The retractable animal leash assembly according to claim 10, wherein the trigger handle is located on the underside of the housing such that in normal use a user's fingers are wrapped around the trigger handle.

12. The retractable animal leash assembly according to any one of claims 10 to 11, wherein the trigger handle is pivotable with respect to the housing and a small movement in the trigger handle can be used to bring the attachment clip into the active position in which the latch portion is in the open configuration.

13. The retractable animal leash assembly according to claim 12, wherein the trigger handle can be released and this results in the bias forcing the attachment clip to the non-active position and the latch portion to the locked position.

14. The retractable animal leash assembly according to any one of claims 10 to 13, wherein the trigger handle is biased to a non-depressed position in which the attachment clip is in the non-active position.

15. The retractable animal leash assembly according to any one of claims 2 to 14, wherein lateral movement of the leash and the attachment clip to move the attachment clip between the active and non-active positions is effected by a two way ratchet mechanism.

16. The retractable animal leash assembly according to claim 15, wherein the trigger handle has a pawl at a free end and a ratchet wheel is connected to the retractable reel and is rotatable with respect to the housing and the pawl on the free end of the trigger handle bears against a surface of a tooth on the ratchet wheel such that when the trigger handle is depressed by a user, the pawl engages the ratchet wheel between adjacent teeth and drives a small rotation of the ratchet wheel and the retractable reel, resulting in retraction of the leash further onto the retractable reel which, in turn, forces the latch portion of attachment clip on to the bearing surface which overcomes the bias on the latch portion and forces the latch portion to the open configuration and whilst the trigger handle remains depressed, the pawl is engaged with the ratchet wheel between adjacent teeth and the ratchet wheel and retractable reel are not rotatable and when the trigger handle is released, the pawl drives a small rotation of the ratchet wheel and the retractable reel in the opposite direction to the rotation when the trigger handle is depressed and this results in extension of the leash from the retractable reel which, in turn, releases the latch portion of attachment clip from the bearing surface and the bias on the latch portion results in it returning to the closed configuration.

17. The retractable animal leash assembly according to any one of claims 2 to 16, wherein the retractable reel is biased to a retracted position by a biasing means.

18. The retractable animal leash assembly according to claim 17, wherein the pawl and ratchet wheel together provide a clutch arrangement.

19. The retractable animal leash assembly according to claim 18, wherein when the trigger handle is not depressed, the ratchet wheel and retractable reel are free to rotate and when the trigger handle is depressed, the pawl engages the ratchet wheel and prevents further rotation of the ratchet wheel and the retractable reel.

20. The retractable animal leash assembly according to any one of claims 2 to 19, wherein when the actuator is operated the attachment clip is pulled tightly against the bearing surface which secures the attachment clip from moving and makes it easy to control in three dimensional space and clip onto a collar or harness.

21. The retractable animal leash assembly according to any one of claims 2 to 20, wherein the external surface has a wrist strap connector to which a wrist strap or other suitable tether can be attached.
